(19) United States
(12) Patent Application Publication
(10) Pub. No.: US 2022/0350284 A1
(43) Pub. Date: Nov. 3, 2022

(54) SCANNING PRINTER INCLUDING ELECTROSTATIC DISCHARGE

(71) Applicant: Hewlett-Packard Development Company, L.P., Spring, TX (US)

(72) Inventors: Napoleon Leoni, Palo Alto, CA (US); Omer Gila, Palo Alto, CA (US); Rajesh Kelekar, Palo Alto, CA (US)

(73) Assignee: Hewlett-Packard Development Company, L.P., Spring, TX (US)

(21) Appl. No.: 17/761,356

(22) PCT Filed: Oct. 15, 2019
(86) PCT No.: PCT/US2019/056327

§ 371 Date: Mar. 17, 2022

(51) Int. Cl. G03G 15/32; B41C 1/10; B41J 2/41

(52) U.S. Cl. CPC G03G 15/321; B41C 1/105; B41J 2/41

(57) ABSTRACT

A scanning carriage of a printer includes a first emitter to emit first airborne charges, a second emitter to emit second airborne charges, and a fluid ejection device interposed between the first and second emitters to deposit droplets of ink particles within a non-aqueous fluid carrier onto a print medium to form an image. The carriage is movable relative to the print medium in a first direction and an opposite second direction. In the first direction, the first emitter is to electrostatically discharge the medium and the second emitter is to induce electrostatic fixation of the ink particles relative to the medium. In the opposite second direction, the second emitter is to electrostatically discharge the medium and the first emitter is to induce electrostatic fixation of the ink particles relative to the medium.

### BACKGROUND

Modern printing techniques involve a wide variety of media, whether rigid or flexible, and for a wide range of purposes. One type of printing involves a scanning back-and-forth movement of a carriage across a width of a print medium such that multiple passes are made over a particular portion of the print medium in order to form an image thereon.

### BRIEF DESCRIPTION OF THE DRAWINGS

FIG. 1 is a diagram including a side view schematically representing an example image formation device and/or example method of image formation.

FIGS. 2A-2D are a series of diagrams, each including a side view schematically representing at least some aspects of an example image formation device and/or an example method of image formation.

FIG. 3A is a block diagram schematically representing an example liquid removal element.

FIG. 3B is a side view schematically representing an example fluid ejection device.

FIGS. 4A-4D are a series of diagrams schematically representing example image formation on a medium.

FIG. 5 is a diagram including a top view schematically representing an example scanning-type image formation device and/or method of image formation.

FIG. 6 is a diagram including a side view schematically representing an example image formation device and/or example method of image formation.

FIG. 7A is a diagram including a side view schematically representing an example image formation device.

FIG. 7B is a graph schematically representing an AC-based discharge signal in an example method of image formation.

FIG. 8 is a side view schematically representing an example corona-type charge source.

FIG. 9 is a diagram including a side view schematically representing an example image formation device.

FIG. 10A is a side view schematically representing an example image formation device including an example scorotron-type charge source.

FIG. 10B is a graph schematically representing an AC-based discharge signal associated with the example scorotron-type charge source in an example method of image formation.

FIGS. 11A and 11B are a block diagram schematically representing an example control portion and an example user interface, respectively.

FIG. 12 is a flow diagram schematically representing an example method of image formation.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

In at least some examples of the present disclosure, a scanning carriage of a printer includes a first emitter to emit first airborne charges, a second emitter to emit second airborne charges, and a fluid ejection device interposed between the first and second emitters to deposit droplets of ink particles within a non-aqueous fluid carrier onto a print medium to form an image. The scanning carriage is movable relative to the print medium in a first direction and an opposite second direction. In the first direction, the first emitter is to electrostatically discharge the medium and the second emitter is to induce electrostatic fixation of the ink particles relative to the print medium. In the opposite second direction, the second emitter is to electrostatically discharge the medium and the first emitter is to induce electrostatic fixation of the ink particles relative to the printer medium. Accordingly, each of the first emitter and the second emitter may alternately act in a discharging mode and a charging mode, with the particular mode selected depending on the direction of travel of the carriage.

In some such examples, both of the first and second directions extend along a first orientation which is transverse to a second orientation, which corresponds to an advance direction of the print medium, i.e. a substrate advance direction. In such examples, the carriage is generally fixed along the second orientation but moves in a back-and-forth scanning motion along the first orientation, such as moving across a width of the print medium while forming an image on the print medium.

Via such arrangements, when either the first emitter or the second emitter are in a leading position as the carriage moves across a width of the print medium, the respective emitter acts to neutralize surface charges on the print medium, such as surface charges which remain from a prior pass during which the other respective emitter had emitted charges to cause electrostatic fixation of deposited ink particles (jetted within droplets from the fluid ejection device. In this way, example image formation devices (and/or methods) produce a printing zone beneath the fluid ejection device (as the carriage moves) which may be charge-neutral to facilitate jetting of the droplets (including the ink particles) and/or facilitate electrostatic migration and fixation of the ink particles relative to print medium.

More particularly, a carriage in an offjet-type, scanning printer may involve overlap of printing passes (e.g. swaths) across the print medium as well as making multiple passes over the same area of the print medium to achieve the desired print density. For example, with an overlap of a predetermined percentage between scans (e.g. printing passes), the fluid ejection device prints just a portion (e.g. the predetermined percentage) of the target total print density in the first printing pass of the carriage and the fluid ejection device prints the remaining ink (to achieve 100% of the target total print density) in the second pass of the carriage. In some examples, the degree of overlap may be up to 50 percent, while in some examples, the degree of overlap may be much smaller, such as 10 percent.

In accordance with examples of the present disclosure, the use of an emitter in a leading position to discharge surface charges on the print medium (in addition to a trailing emitter to charge ink particles per examples of the present disclosure) may help to avoid a significant charge build-up on the surface of the print medium which might otherwise occur due to the multiple overlapping passes in which a charging emitter (in the absence of a discharging emitter) continues to add additional charges to an already charged surface of the print medium. Such a charge build-up on the print medium could be on the order of hundreds to thousands of Volts potential, depending on a thickness of the print medium or substrate.

In one aspect, a leading discharging emitter on a scanning carriage (per at least some examples of the present disclosure) may act to neutralize charges remaining from a prior printing pass, which were used to electrostatically fix the ink particles to the print medium. Without their removal, such remaining charges might otherwise act to electrically screen (e.g. inhibit) the next round of charges (in the next printing pass) emitted to induce electrostatic fixation of ink particles relative to the print medium.

Moreover, neutralizing charges from a prior printing pass (via a leading discharging emitter on a scanning carriage per at least some examples of the present disclosure) also neutralizes a high potential (e.g. Voltage) associated with such remaining charges which may otherwise hinder jetting droplets from the fluid ejection device. The presence of such high field (e.g. potential) at the surface of the print medium may cause charge separation/polarization of the jetted droplets prior to their intended breakup which could lead to jetting of electrically charged droplets, which in turn could cause drop placement errors. In other words, via at least some examples of the present disclosure including a leading discharging emitter (among other features in some instances), jetted droplets (including ink particles) become more likely to reach their target locations on the print medium, thereby leading to higher quality (e.g. clearer) image formation on the print medium.

In addition, the provision of a leading discharging emitter to neutralize the surface of the pint medium may enhance spatial uniformity on the print medium because any stitching area resulting from overlaps in printing passes may have a substantially charge-free surface which better matches unprinted portions of the print medium, which lack surface charges (at least those produced by the carriage). Moreover, use a leading discharging emitter to neutralize surface charges per at least some examples of the present disclosure, may neutralize charges which might otherwise radiate out from the edges of an emitter.

It will be further understood that example of present disclosure may include omitting emission of discharging charges (e.g. negative) on a first pass of carriage over fresh non-printed portions of the print medium.

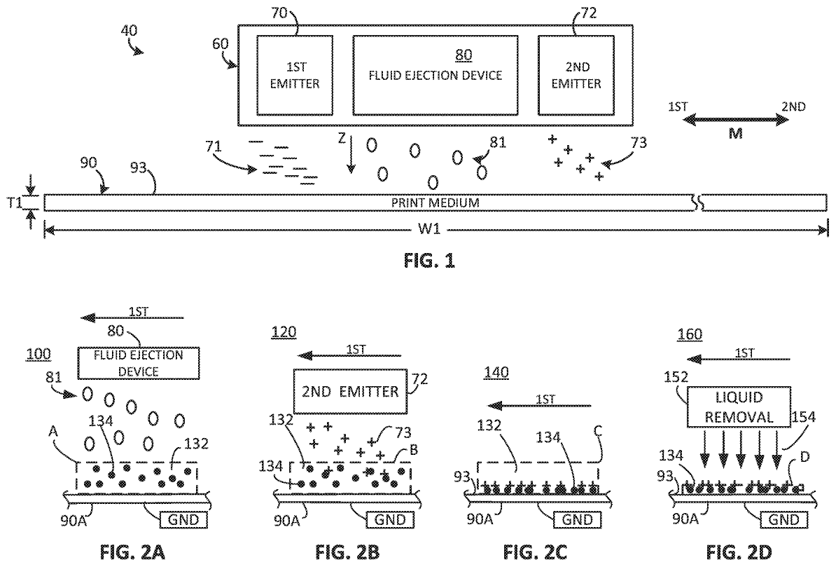

These examples, and additional examples, will be further described below in association with at least FIGS. 1-12.

FIG. 1 is a diagram including a side view schematically representing an example image formation device 40 and/or example method of image formation. As shown in FIG. 1, the image formation device 40 comprises a scanning carriage 60 supporting a fluid ejection device 80 which is interposed between a first emitter 70 and a second emitter 72. In this arrangement, the first emitter 70 is adjacent a first end 62 of the carriage 60 and the second emitter 72 is located adjacent an opposite second end 62 of the carriage 60. As represented by directional arrow M in FIG. 1, the carriage 60 is movable (arrow M) relative to a print medium 90 in a first direction and an opposite second direction.

Image formation on the print medium is performed during a scanning back-and-forth movement of the carriage 60 across a width (W1) of the print medium (as represented via directional arrow M), during which the fluid ejection device 80 is to deposit droplets 81 of ink particles within a non-aqueous carrier fluid onto the print medium 90. In some such examples, depending on the particular pass being made in the course of scanning-type printing, one or both of the first emitter 70 and second emitter 72 may emit charges 71, 73, respectively to ensure robust jetting of droplets 81 and/or to enable electrostatic fixation of ink particles within the droplets 81 jetted by the fluid ejection device 80. These details will be further described later in association with at least FIGS. 2A-2D and other FIGS within the present disclosure.

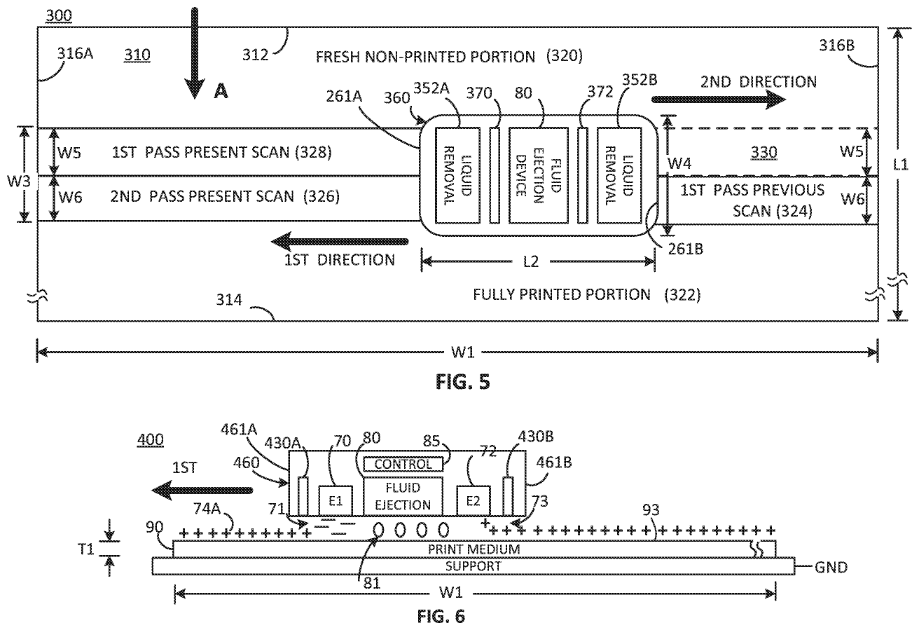

In some such examples, the back-and-forth scanning movement of carriage 60 is performed in a first orientation, with it being understood that the print medium 90 may be advanced periodically in a second orientation transverse to the first orientation, as further illustrated later in association with at least FIG. 5. In some such examples, both of the first and second directions extend along the first orientation which is transverse to the second orientation, which corresponds to an advance direction of the print medium, i.e. a substrate advance direction. In such examples, the carriage is generally fixed along the second orientation but moves in a back-and-forth scanning motion along the first orientation, such as moving across a width of the print medium while forming an image on the print medium.

In at least some instances, when the carriage 60 moves in the first direction, the first emitter 70 is to electrostatically discharge the medium 90 and the second emitter is to induce electrostatic fixation of the ink particles relative to the medium 90. In at least some instances, when the carriage 60 moves in the opposite second direction, the second emitter is to electrostatically discharge the medium 90 and the first emitter is to induce electrostatic fixation of the ink particles relative to the medium.

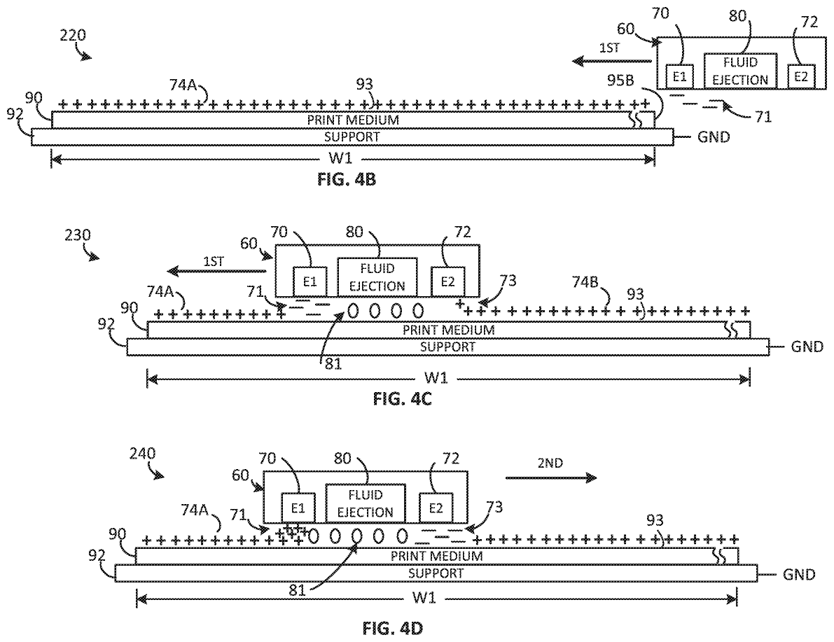

In some examples, when acting in a discharge mode, the first emitter 71 or second emitter 72 (depending on the direction of movement M) emits charges to neutralize any charges on or at a surface of the print medium 90 which remain from a prior pass of the carriage 90 during the scanning-type printing. Depending on the particular example, such charges may be negative or positive. In the example shown in FIG. 1 in which emitter 70 is in a leading position when carriage 60 moves in the first direction, negative charges 71 are emitted to discharge positive charges at the surface of print medium 90, as further shown and described later in at least FIGS. 4A-4D. In some such examples, the emitted charges 71 act to discharge surface charges on print medium 90 help to ensure that the droplets 81 of ink particles (within a carrier fluid) jetted by fluid ejection device 80 will be unaffected by such surface charges. In addition, the discharge (via emitted charges 71) of such surface charges also help to ensure a robust electrostatic fixation of ink particles within the droplets 81 relative to the print medium 90, which is further described below in association with at least FIGS. 2B-2D.

FIGS. 2A-2D are a series of diagrams schematically representing at least some aspects of image formation device (and/or method) associated with the image formation device and/or method described in association with at least FIG. 1. In particular, each of the FIGS. 2A-2D represents a different snapshot in time during a method of image formation on print medium 90. Accordingly, for illustrative purposes, each of FIGS. 2A-2D depict a particular portion 90A of print medium 90 to which various aspects of image formation are performed as a carriage (e.g. 60 in FIG. 1) is moved across a width of the print medium 90 in a scanning-type printer. Further details regarding such scanning-type image formation are provided later in association with at least FIGS. 4A-4D, 5.

As shown in FIG. 2A, in some examples one aspect of image formation comprises fluid ejection device 80 depositing droplets 81 of ink particles 134 within a dielectric carrier fluid 132 on the print medium 90, as carriage 60 moves in the first direction. As depicted within the dashed lines A in FIG. 2, deposited droplets 81 result in ink particles 134 being suspended within carrier fluid 132 on medium 90, with ink particles 134 having a location and/or spacing which begins to form at least a portion of an image on portion 90A of medium 90. In some examples, the droplets 81 (which include ink particles 134) may comprise pigments, dispersants, the carrier fluid 132, and may comprise additives such as bonding polymers.

In some examples, the fluid ejection device 80 comprises a drop-on-demand fluid ejection device. In some examples, the drop-on-demand fluid ejection device comprises an inkjet printhead. In some examples, the inkjet printhead comprises a piezoelectric inkjet printhead. In some examples, the fluid ejection device 80 may comprise other types of inkjet printheads. In some examples, the inkjet may comprise a thermal inkjet printhead. In some examples, the droplets may sometimes be referred to as being jetted onto the media. With this in mind, example image formation according to at least some examples of the present disclosure may sometimes be referred to as “jet-on-media”, “jet-on-substrate”, “offjet printing”, and the like.

In some examples, print medium 90 comprises a metallized layer or foil to which a ground element GND is electrically connected. In some examples, an electrically conductive element separate from the print medium 90 is provided to contact the medium 90 in order to implement grounding of the medium 90.

Through further movement of carriage 60 (e.g. in the first direction) relative to portion 90A of medium 90, additional aspects of image formation are performed on or relative to portion 90A following the operation of fluid ejection device 80 depicted in FIG. 1. Accordingly, FIG. 2B depicts the operation of 2^{nd} emitter 72 on portion 90A of medium 90 in which 2^{nd} emitter 72 emits airborne charges 73 to charge the ink particles 134, as represented via the depiction in dashed lines B in FIG. 2B. Once charged, the ink particles 134 move, via electrostatic attraction relative to the grounded medium 90, through the carrier fluid 132 toward the medium 90 to become electrostatically fixed on the medium 90 (represented via the depiction in dashed lines C in FIG. 2C), as the carriage 60 continues to move (e.g. in the first direction) across a width of the medium 90.

As will be further appreciate from FIG. 2C, with the ink particles 134 electrostatically pinned against the print medium 90, the carrier fluid 132 exhibits a supernatant relationship relative to the ink particles 134.

With continued movement of carriage 60 relative to print medium 90, a further aspect of the example image formation comprises operation of a liquid removal device 152, as depicted in FIG. 2D. In particular, as shown in FIG. 2D, liquid removal device 152 exerts energy toward the carrier fluid 132, ink particles 134, and medium 90 (shown in FIG. 2C) to cause evaporation of liquid, which includes at least carrier fluid 132, resulting in just ink particles 134 remaining on medium 90 as shown in FIG. 2D. In some such examples, the liquid removal device 152 also may be supported by carriage 60, such as shown in FIG. 4 which is later described in more detail. In some examples, the liquid removal device 152 may be attachable to the carriage 60. In some examples, the liquid removal device 152 acts to partially evaporate carrier liquid 132 on print medium 90 with the remaining liquid 132 being evaporated or dried at a later stage of the overall printing process.

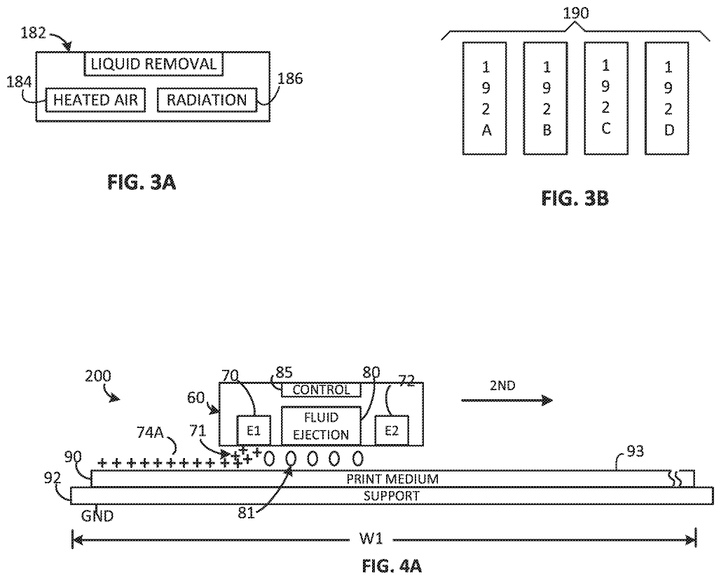

As shown in FIG. 3A, in some examples a liquid removal device 182 may comprise one example implementation of liquid removal device 152 in FIG. 2D. In some examples, the liquid removal device 182 may comprise a heated air element 184 to direct heated air onto at least the carrier fluid 132 and medium 90, such as in FIG. 2D. In some examples, the heated air is controlled to maintain the ink particles 134, medium 90, etc. at a temperature below 60 degrees C., which may prevent deformation of medium 90, such as cockling, etc.

As further shown in FIG. 3A, in some examples, the liquid removal portion 182 may comprise a radiation element 186 to direct at least one of infrared (IR) radiation and ultraviolet (UV) radiation onto the liquid 132 and media 90 to remove the liquid, as shown in FIG. 2D. In some examples, the liquid removal portion 182 may sometimes be referred to as an energy transfer mechanism or structure by which energy is transferred to the liquid 132, ink particles 134, and medium 90 in order to dry the ink particles 134 and/or media 124.

With further reference to at least FIGS. 1 and 2A-2D, in some examples, as part of ejecting droplets (e.g. 81 in FIG. 2A), the fluid ejection device 80 is to deposit the dielectric carrier fluid 132 on the medium 90 as a non-aqueous liquid. In some examples, the non-aqueous liquid comprises an isoparafinic fluid, which may be sold under the trade name ISOPAR. In some such examples, the non-aqueous liquid may comprise other oil-based liquids suitable for use as a dielectric carrier fluid.

With further reference to FIG. 2B, in some examples the second emitter 72 may comprise a corona, plasma element, or other charge generating element to generate a flow of charges. Accordingly, the second emitter 72 may sometimes be referred to as a charge source, charge generation device, and the like. The generated charges may be negative or positive as desired. In some examples, the 2^{nd} emitter 72 comprises an ion head to produce a flow of ions as the charges. It will be understood that the term “charges” and the term “ions” may be used interchangeably to the extent that the respective “charges” or “ions” embody a negative charge or positive charge (as determined by device 72). In at least some examples, the first emitter 70 may comprise substantially the same features and attributes as 2^{nd} emitter 72.

In the particular instance shown in FIG. 2B, the charges 73 emitted by 2^{nd} emitter 72 when the carriage 60 is moving in a first direction (e.g. 1^{st} in FIG. 1) can become attached to the ink particles 134 to cause all of the charged ink particles to have a particular polarity, which will be attracted to ground. In some such examples, all or substantially all of the charged ink particles 134 will have a negative charge or alternatively all or substantially all of the charged ink particles 134 will have a positive charge.

It will be further understood that in at least some examples, such as when the carriage 60 is moving in the opposite second direction (arrow header 2^{nd}), the 1^{st} emitter 70 (FIG. 1) follows the fluid ejection device 80 (which jets droplets 81 including ink particles 134) and the 1^{st} emitter 70 is to emit charges to induce electrostatic migration and fixation of the ink particles 134 relative to the print medium 90. In some such examples, the 2^{nd} emitter is in a leading position and precedes the fluid ejection device 80 when carriage 60 moves in the second direction (e.g. 2^{nd} in FIG. 1) and may emit negative charges 73 to neutralize any charges on surface of print medium 90 prior to the jetting and/or electrostatic fixation induced by charges emitted by 1^{st} emitter 70 which follows the fluid ejection device 80, as further shown in FIG. 5D.

Via such example arrangements such as depicted in FIGS. 2A-2D, the charged ink particles 134 become electrostatically fixed (e.g. pinned) on the medium 90 in a location on the medium 90 generally corresponding to the location (in an x-y orientation) at which they were initially received onto the medium 130 as jetted via fluid ejection device 80 of the image formation device 100. Via such electrostatic fixation, the ink particles 134 will retain their position on medium 90 even when other ink particles (e.g. different colors) are added later, excess liquid is physically removed, etc. It will be understood that while the ink particles may retain their position on medium 90, some amount of expansion of a dot (formed of ink particles) may occur after the ink particles 134 (within carrier fluid 132) are jetted onto medium 90 and before they are electrostatically pinned (i.e. electrostatically fixed).

In some examples, the 1^{st} emitter 70 and the 2^{nd} emitter 72 are both spaced apart by a predetermined distance from the fluid ejection device 80 (from which the droplets 81 are received) in order to delay the electrostatic fixation (per operation of 2^{nd} emitter 72 or of 1^{st} emitter 70 depending on the direction of movement M), which can increase a dot size on medium 90, which in turn may lower ink consumption.

In some examples, the ground element GND may comprise an electrically conductive element in contact with a portion of the medium 90. In some examples, the electrically conductive element may comprise a roller or plate in rolling or slidable contact, respectively, with a portion of the media. In some examples, the ground element GND is in contact with an edge or end of the media. In some examples, the electrically conductive element may take other forms, such as a brush or other structures. Accordingly, it will be understood that the ground element GND is not limited to the particular location shown in FIGS. 2A-2D.

In some examples, the print medium 90 comprises a non-absorbing material, non-absorbing coating, and/or non-absorbing properties. Accordingly, in some examples the medium is made of a material which hinders or prevents absorption of liquids, such as a carrier fluid and/or other liquids in the droplets received on the medium. In one aspect, in some such examples the non-absorbing medium does not permit the liquids to penetrate, or does not permit significant penetration of the liquids, into the surface of the non-absorbing medium.

The non-absorbing example implementations of the print medium 90 stands in sharp contrast to some forms of media, such as paper, which may absorb liquid. The non-absorbing attributes of the medium 90 may facilitate drying of the ink particles on the media at least because later removal of liquid from the media will not involve the time and expense of attempting to pull liquid out of the media (as occurs with absorbing media) and/or the time, space, and expense of providing heated air for extended periods of time to dry liquid in an absorptive media.

Via the example arrangements, the example device and/or associated methods can print images on a non-absorbing medium (or some other medium) with minimal bleeding, dot smearing, etc. while permitting high quality color on color printing. Moreover, via these examples, image formation on a non-absorbing medium (or some other medium) can be performed with less time, less space, and less energy at least due to a significant reduction in drying time and capacity. These example arrangements stand in sharp contrast to other printing techniques, such as high coverage, aqueous-based step inkjet printing onto non-absorbing medium for which bleeding, dot smearing, cockling, etc. may yield relatively lower quality results, as well as unacceptably high cost, longer times, etc. associated with drying.

In some such examples, the non-absorptive medium 90 may comprise other attributes, such as acting as a protective layer for items packaged within the media. Such items may comprise food or other sensitive items for which protection from moisture, light, air, etc. may be desired.

With this in mind, in some examples the medium 90 may comprise a plastic media. In some examples, the medium 90 may comprise polyethylene (PET) material, which may comprise a thickness on the order of about 10 microns. In some examples, the medium 90 may comprise a biaxially oriented polypropylene (BOPP) material. In some examples, the medium 90 may comprise a biaxially oriented polyethylene terephthalate (BOPET) polyester film, which may be sold under trade name Mylar in some instances. In some examples, the medium 90 may comprise other types of materials which provide at least some of the features and attributes as described throughout the examples of the present disclosure. For examples, the medium 90 or portions of medium 90 may comprise a metallized foil or foil material, among other types of materials.

In some examples, print medium 90 comprises a flexible packaging material. In some such examples, the flexible packaging material may comprise a food packaging material, such as for forming a wrapper, bag, sheet, cover, etc. As previously mentioned for at least some examples, the flexible packaging materials may comprise a non-absorptive media.

In some examples, the image formation device may sometimes be referred to as a printer or printing device. In some examples in which a media is supplied in a roll-to-roll arrangement or similar arrangements, the image formation device may sometimes be referred to as a web press and/or the print medium can be referred to as a media web.

At least some examples of the present disclosure are directed to forming an image directly on a print medium, such as without an intermediate transfer member. Accordingly, in some instances, the image formation may sometimes be referred to as occurring directly on the print medium. However, this does not necessarily exclude some examples in which an additive layer may be placed on the print medium prior to receiving ink particles (within a carrier fluid) onto the print medium. In some instances, the print medium also may sometimes be referred to as a non-transfer medium to indicate that the medium itself does not comprise a transfer member (e.g. transfer blanket, transfer drum) by which an ink image is to be later transferred to another print medium (e.g. paper or other material). In this regard, the print medium may sometimes also be referred to as a final medium or a media product. In some such instances, the medium may sometimes be referred to as product packaging medium.

In some examples, the non-transfer medium may sometimes be referred to as a non-transfer substrate, i.e. a substrate which does not act as a transfer member (e.g. a member by which ink is initially received and later transferred to a final substrate bearing an image).

In some examples, fluid ejection device 80 (e.g. FIGS. 1, 2A) may comprise a permanent component of image formation device 100, which is sold, shipped, and/or supplied, etc. as part of image formation device 100. It will be understood that such “permanent” components may be removed for repair, upgrade, etc. as appropriate. However, in some examples, fluid ejection device 80 may be removably received, such as in instances when fluid ejection device 80 may comprise a consumable, be separately sold, etc.

FIG. 3B is a diagram including a side view schematically representing an example fluid ejection device 190, which comprise at least some of substantially the same features and attributes as fluid ejection device 80 as previously described in association with FIGS. 1, 2A. In some examples, fluid ejection device 190 may comprise an example implementation of fluid ejection device 80 in association with at least FIGS. 1, 2A. As shown in FIG. 3B, in some examples, the fluid ejection device 190 comprises a series of fluid ejection elements (e.g. printheads) 192A, 192B, 192C, 192D arranged on the carriage 60 in series, with each fluid ejection element provides one color ink of a plurality of different color inks onto the media.

In some examples, each different fluid ejection element 192A-192D provides for at least partial formation of an image on print medium 90 by a respectively different color ink. Stated differently, the different fluid ejection elements 192A, 192B, 192C, 192D apply different color inks such that a composite of the differently colored applied inks forms a complete image on print medium 90 as desired. In some examples, the different color inks correspond to the different colors of a color separation scheme, such as Cyan (C), Magenta (M), Yellow (Y), and black (K) wherein each different color is applied separately as a layer to the print medium 90 as carriage 60 moves across the print medium 90.

In some examples, the fluid ejection device 190 may comprise a fewer number or a greater number of fluid ejection elements (e.g. printheads) than shown in FIG. 3B.

In some examples, as further described later in association with at least FIG. 11A, among directing other and/or additional operations, a control portion 1100 is instruct, or to cause, the fluid ejection device 80 to deliver the droplets of ink particles 134 within the dielectric carrier fluid 32 onto the media 24 (FIG. 2A), to cause operation of emitters 70, 72 to emit airborne charges 71, 73 (FIG. 1) with an appropriate polarity (e.g. negative or positive), apply energy to remove liquid (FIG. 2D), etc.

FIGS. 4A-4D are a series of diagrams, each including a side view schematically representing an example image formation device 60 and/or example method 200 of image formation. In some examples, the image formation device and/or example method 200 may comprise at least some of substantially the same features and attributes as the example image formation devices/methods as previously described in association with FIGS. 1-3B.

As shown in FIG. 4A, in some examples when a scanning carriage 60 makes a first pass across a portion of a print medium 90, the surface 93 of the print medium 90 may be relatively free of applied surface charges. Accordingly, in such instances, as the carriage 90 moves across a width of the print medium (e.g. the 2^{nd} direction in this example), the second emitter 72 does not emit charges (e.g. negative charges) because the situation does not call for neutralizing charges at surface 93. As further shown in FIG. 4A, the fluid ejection device 80 jets droplets 81 including ink particles 134 and the first emitter 70 emits charges (e.g. positive) in order to induce electrostatic fixation of ink particles relative to the print medium 90 in a desired pattern to cause image formation, as previously described in association with at least FIGS. 2A-2C.

As further shown in FIG. 4A, in some examples the scanning carriage 60 may comprise a control portion 85, which in some examples may comprise one example implementation of at least a portion of the control portion 1100 described later in association with at least FIG. 11A. In some examples, the control portion 85 may communicate with portions of the control portion 1100 external to the carriage 60. The control portion 85 may control, at least, operation of the fluid ejection device 80, emitters 70, 72, and/or movement of carriage 60. It will be further understood that while some FIGS within the present disclosure may omit a control portion 85 for illustrative simplicity, in some examples such a control portion 85 may be incorporated into (and/or be in communication with) the carriage 60 and/or elements supported by the carriage 60 described in association with FIG. 1, FIGS. 2A-2D, 3A-3B, FIGS. 4A-4D, and FIGS. 5, 6, 7A, 9, and 10A.

With further reference to FIG. 4A, after the scanning carriage 60 has completely passed over the width of the print medium 90 in the second direction, the scanning carriage 60 will be positioned beyond an outer edge 95B of the print medium and begin preparation for the next scanning pass over the print medium as depicted in FIG. 4B. As shown in FIG. 4B, surface 93 of print medium 90 exhibits surface charges 74A resulting from the positive charges 71 emitted by first emitter 70 in the prior pass of carriage 60. Accordingly, in order to neutralize these surface charges 74A prior to further image formation on print medium in the next pass, first emitter 70 switches its operating polarity to emit negative charges 71 (FIG. 4B) as the scanning carriage starts its next pass in the first direction as represented per 1^{st} directional arrow.

FIG. 4C schematically represents the scanning carriage 60 after it has passed partially across the print medium from the start position shown in FIG. 4B and continues in the first direction to complete a full pass across the width of the print medium 90. In a manner similar to that shown in FIG. 4A, the fluid ejection device 80 jets droplets 81 to deposit ink particles 134 (e.g. FIG. 2A) onto print medium 90 while the second emitter 72 emits charges (e.g. positive) to induce electrostatic migration and fixation of the ink particles 134 against the print medium 90 (e.g. FIGS. 2B-2C). In addition, in a manner similar to that shown in FIG. 4B, the first emitter 70 emits charges (e.g. negative) to electrostatically discharge or neutralize the positive surface charges 74A ahead of the scanning carriage 60 and remaining from the previous pass of the carriage, such as in FIG. 4A. Via this arrangement, the first emitter 70 acts to create a generally neutral charge environment in the printing zone over the surface 93 of print medium 90 in order to facilitate jetting and/or electrostatic fixation, as previously described in association with at least FIGS. 2A-2C.

From the position shown in FIG. 4C, the scanning carriage 60 continues movement across the width of the print medium 90 until a complete pass of carriage 60 has been made.

As further shown in FIG. 4D, another pass in the second direction is made by the scanning carriage 60 in a manner similar to that shown in FIG. 4C, except with the second emitter 72 being in a leading position and emitting negative charges 73 to discharge or neutralize the positive surface charges 74A on surface 93 of print medium 90. In this arrangement, the first emitter 70 is now in a trailing position and emits positive charges 71 to induce the electrostatic migration and fixation of the ink particles 134 (deposited via droplets 81) to at least partially form the desired image. In one aspect, the scanning pass in FIG. 4D is like that of FIG. 4A, except that in FIG. 4D the leading emitter (e.g. second emitter 72) emit charges to neutralize surface charges 74A on print medium 90 whereas in FIG. 4A, the leading emitter 72 does not emit such neutralizing charges because no surface charges 74A are present on surface 93 of print medium 90.

It will be understood that additional, subsequent passes like those in FIGS. 4A-4D will continue to be made until the desired image is formed on the print medium 90.

With this in mind, FIG. 5 is a diagram 300 including a top view schematically representing an example image formation device 300 and/or example image formation method. In some examples, the image formation device 300 comprises a scanning carriage 360 which comprises at least some of substantially the same features and attributes as carriage 60 and the associated image formation devices/methods as described in association with at least FIGS. 1-4D.

As shown in FIG. 5, a print medium 310 like print medium 90 is made available for printing via the scanning carriage 360. The print medium 310 comprises top edge 312 and opposite bottom edge 314, as well as opposite side edges 316A, 316B. The print medium 310 can be a sheet or a continuous web of the medium, with L1 designating a length of the print medium 310. In either case, it will be understood that a just a portion of a full size print medium is shown for illustrative simplicity.

As previously mentioned, the print medium 310 moves relative to the carriage 260 in a substrate advance direction, as represented by directional arrow A. As such a fully printed portion 322 of print medium 310 is shown in FIG. 5 below the scanning carriage 360 while a fresh non-printed portion 320 of the print medium 310 is shown above the scanning carriage 360. Moreover, as indicated by directional arrows 1^{st} and 2^{nd}, the scanning carriage 360 moves in a back-and-forth motion across the width W1 of the print medium 310 with the scanning carriage 360 having a length L2 which is less than the width W1 of print medium 310. In some examples, the length L2 is substantially less than W1, such as at least 50 percent less than W1. In addition, the overall width W4 of the scanning carriage is substantially less than a length L2 of the carriage 360.

In some examples, the scanning carriage 360 comprises an effective printing width W3, which is less than the full width W4 of the carriage 360. The effective printing width W3 generally corresponds to the length portion (e.g. W3) of the print medium 90 printed in a single pass of the scanning carriage across a width W1 of the print medium 310.

As further shown in FIG. 5, in some examples, the scanning carriage 360 also may print portions of the image (to be formed) in overlapping passes. For instance, in some examples the scanning carriage 360 may be configured and/or programmed such that a single pass of the scanning carriage 360 results in a first pass present scan 328 printed via a portion (e.g. half) of the fluid ejection device 80 and an adjacent second pass present scan 326 printed via another portion (e.g. half) of the fluid ejection device 80. In some examples, the first pass present scan 328 has a width W5 while the second pass present scan 328 has a width W6, with a sum of widths W5 and W6 equally the effective width W3 of the scanning carriage 60, as noted above.

As further shown in FIG. 5, a first pass 324 from a previous scan of the carriage 360 is visible ahead of the carriage 360 as it moves in the 2nd direction across the width W1 of the print medium 310, with the second pass 326 of the present scan aligned with the first pass previous scan 324. Upon further movement of the carriage 360 in the 2nd direction, a second printing pass will be applied over the exposed first pass previous scan portion 324.

In a similar manner, FIG. 5 shows a target portion 330 (shown in dashed lines) to be printed as part of the first pass present scan 328 upon continued movement of the carriage 360 (in the 2nd direction) across the entire width W1 of the print medium 310. In some instances, the target portion 330 may be considered part of the fresh non-printed portion 220 of the print medium 310.

As the carriage 360 moves in the 2nd direction across the width W1 of the print medium 310, the various elements of the carriage operate to form an image on the print medium in a manner substantially similar to that previously described in association with at least FIGS. 1-4D and/or later described in association with at least FIGS. 6-12. In some examples, the carriage 360 supports a first emitter 370 (like emitter 70), a second emitter 372 (like emitter 72), and a fluid ejection device 80 interposed between the respective first and second emitters 370, 372. In addition, as shown in FIG. 5, the carriage 360 supports a liquid removal device 352A at one end 261A of the carriage 360 and another liquid removal device 352B at an opposite end 261B of the carriage 360, with the liquid removal devices 352A, 352B comprising at least some of substantially the same features and attributes of liquid removal devices 152, 182 as described in association with at least FIGS. 2D, 3A, respectively. Accordingly, as the carriage 360 at least partially forms an image via fluid ejection device 80 and emitters 370, 372 during the scanning passes of carriage, the liquid removal devices 352A, 352B act to remove the excess liquid (in its supernatant relationship) from the print medium 310 to leave the ink particles 134 in their targeted pattern to form the desired image. In some such examples, such operation of carriage 360 results in ink particles 134 being electrostatically fixed on the print medium 310 in a pattern to form the desired image on print medium 310.

With reference to at least FIGS. 1-5, in some examples an example image formation device is operated to balance the deposited charges used for discharging (discharging remaining surface charges from a prior printing pass) with deposited charges used for charging (e.g. charging ink particles for electrostatic migration/fixation). For instance, in some examples the net current associated with the deposited “discharging” charges may have a substantially equal value to, but an opposite sign (e.g. positive or negative), the net current associated with the deposited “charging” charges. In some examples and in this context, the term “substantially equal” comprises values within 5 percent of each other. In some examples, such balancing may be implemented via control portion 85, 1100 (FIG. 4A, 6), and in some examples, such balancing may be implemented via balance parameter 966.

With this in mind, FIG. 6 is a diagram 400 including a side view schematically representing an example image formation device 405 and/or image formation method. In some examples, the example image formation device 405 may comprise at least some of substantially the same features and attributes as the image formation devices (and portions thereof) as previously described in association with FIGS. 1-5, except further comprising a pair of non-contact electrostatic voltmeters 430A, 430B supported on the carriage 460. In some examples, one voltmeter 430A is located at one end 461A of carriage 460 external to the first emitter 70 and the other voltmeter 430B is located an opposite end 461B of carriage external to the second emitter 72.

In some examples, the respective voltmeters 430A, 430B may be used to implement the previously-described examples and later-described examples of balancing.

In some such examples, each of the first emitter 70 and second emitter 72 may comprise a corona, such as but not limited to the example corona shown in FIG. 8. As shown in FIG. 8, an emitter 650 (e.g. 70, 72) comprises a housing 655 defining a chamber 662 in which a corona wire 664 is mounted and configured to generate charges 673 of a desired polarity, which may either positive or negative. In some examples, the corona of the respective first and second emitters 70, 72 is operated in a DC mode while in some examples, the corona may be operated in AC mode, or in a combined AC and DC mode, as further described below in association with at least FIGS. 6-10B. In some examples, a current reaching the medium 90 may be designated as I_{M} which may be determined as a current (I_{W}) at the corona wire 664 minus the current (I_{C}) reaching the walls of the chamber 662 (e.g. housing). This relationship may be is expressed in equation form at I_{M}=I_{W}−I_{C}, and in which I_{M} also may be referred to a net current of charges reaching the print medium 90.

Any one of the emitters (e.g. 70, 72) described throughout the examples of the present disclosure may comprise at least some of substantially the same features as emitter 650 in FIG. 8.

With further reference to FIG. 6, in some examples when the carriage is moving in a particular scanning direction (e.g. 1st direction in FIG. 6) across the print medium 90, one of the voltmeters (e.g. 430A) will be in a leading position while the other voltmeter (e.g. 430B) will be in a trailing position. In this arrangement, the voltmeter 430A can measure the potential on print medium 90.

Via this arrangement, in some examples such as one of the voltmeters 430A, 430B being in the leading position of the carriage (for a given direction of movement of the carriage), a respective one of the first and second voltmeters 430A, 430B (i.e. electrical potential sensing devices) is to measure a potential of the print medium 90 prior to discharge to enable determination of a current to be applied via a respective one of the first and second emitters (70, 72) to discharge the print medium 90. Moreover, via this arrangement, in some examples such as one of the voltmeters 430A, 430B being in the trailing position of the carriage 60 (for a given direction of movement of the carriage), a respective one of the first and second voltmeters 430A, 430B is to measure a potential of the print medium 90 after charging the ink particles 134 to enable adjustments to the current that is applied via a respective one of the first and second emitters 70,72 to fine tune the electrostatic fixation of the ink particles 134 relative to the print medium 90.

In some examples, using knowledge of the dielectric thickness of the print medium 90 and knowledge of the measured potential per voltmeter 430A, a desired current for the first emitter 70 (e.g. I_{W}) can be computed, such as a desired current of a corona which emits the charges 71 (e.g. negative charges) for discharging the potential from surface charges 74A on the surface 93 of the print medium 90. In one aspect, the dielectric thickness of the print medium 90 may be determined as a thickness (T1) of print medium 90 divided by an electrical permittivity of the print medium 90.

In some examples, the dielectric thickness of the print medium 90 can be derived on a first printing pass (e.g. FIG. 4A) over an electrically neutral print medium 90 by measuring a potential of the trailing voltmeter (e.g. 430B). In such instances, the leading voltmeter 430A in the first printing pass does not emit any charges, such as for neutralizing surface charges on print medium 90 because no such surface charges (from one of emitters 70, 72) are present on print medium 90 before the first printing pass.

In particular, the desired current for the first emitter 70 may be computed and/or the measured potential may be tracked via a control portion, such as control portion 85 (e.g. FIG. 4A) which may form part of and/or be in communication with elements (e.g. emitters 70, 72, voltmeters 430A, 430B) of the carriage 460. In some such examples, this arrangement of the carriage 460 may sometimes be referred to as a control loop or feedback loop between the voltmeter 430A and emitter 70, and between the voltmeter 430B and emitter 72.

In some examples, the emitters 70, 72 of carriage 460 may comprise a corona wire (e.g. 664) operated in a DC mode.

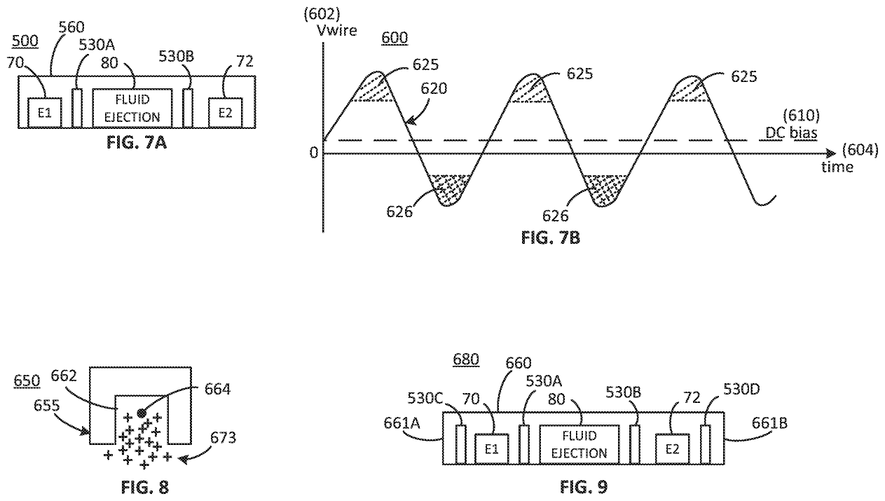

FIG. 7A is a diagram including a side view schematically representing an example image formation device 500. In some examples, the example image formation device 500 may comprise at least some of substantially the same features and attributes as the image formation devices (and portions thereof) as previously described in association with FIGS. 1-6, except further comprising a pair of electrostatic voltmeters 530A, 530B supported on the carriage 460. In some examples, one voltmeter 530A is interposed between the first emitter 70 and the fluid ejection device 80 while the other voltmeter 530B is interposed between the second emitter 72 and the fluid ejection device 80.

In some such examples, upon being in the leading position as carriage 560 moves relative to print medium 90, a respective one of the first and second voltmeters is to measure a potential of the print medium 90 after the discharge to enable control of a DC bias level of an AC discharge current of the respective first and second emitters (70, 72) in order to discharge the print medium 90. For instance, when carriage 560 is moving in a first direction in which emitter 70 is in a leading position, then voltmeter 530A measures the potential of the print medium 90 after discharging the surface of print medium 90 via charges emitted by emitter 70. Similarly, when carriage 560 is moving in an opposite second direction in which emitter 72 is in a leading position, then voltmeter 530B measures the potential of the print medium 90 after discharging the surface of print medium 90 via charges emitted by emitter 72.

In this way, this configuration enables using feedback from measured potential to control in real time the DC bias of the AC corona to achieve better discharging.

In one aspect, the emitters 70, 72 of image formation device 400 may be operated with an AC bias. Such an arrangement may provide enhanced adaptability to spatial non-uniformity in the charging and/or discharging processes. In some such examples of operating with an AC bias, a DC bias level may be selected to provide a best approximation to a neutral state of the print medium in the print zone.

FIG. 7B is a graph 600 schematically depicting the potential (e.g. V_{WIRE}) of the AC-biased corona wire (e.g. 664) of the respective emitters 70, 72 for an example image formation device (e.g. FIG. 7A) when operated in a discharge mode. As shown in FIG. 7B, graph 600 comprises a voltage signal 620 plotted over time (604) and which demonstrates positive discharge behavior 625 and negative discharge behavior 626 for the AC-biased corona wire of the respective emitters 70, 72. FIG. 7B also illustrates a DC bias of the corona wire, per dashed line 610.

FIG. 9 is a diagram 650 including a side view schematically representing an example image formation device 680. In some examples, the example image formation device 680 may comprise at least some of substantially the same features and attributes as the image formation devices (and portions thereof) as previously described in association with FIG. 7A, except further comprising a second pair of electrostatic voltmeters 530C, 530D supported on the carriage 660. In some examples, one voltmeter 530C is located at one end 661A of carriage 460 external to the first emitter 70 and the other voltmeter 530D is located an opposite end 661B of carriage external to the second emitter 72, while the previously identified voltmeters 530A, 530B have the same location as in the example of FIG. 7A.

In comparison to the example in FIG. 7A, the additional voltmeters 530C, 530D result in having a voltmeter on each side of each respective emitter 70, 72 such each emitter 70 is interposed or sandwiched between a pair of voltmeters, e.g. 530A, 530C and 530B, 530D.

Among other aspects, in some examples this configuration enables a closed loop validation of achieving the target values (e.g. 0V) of the emitters 70, 72 when each respective emitter is operated in a discharging mode (i.e. emitting charges to discharge surface charges at print medium 90) within a tolerance (roughly ±200V). In some examples this configuration provides a closed loop validation of achieving the target values (e.g. up to a few kiloVolts) of the emitters 70, 72 when operated in a charging mode (e.g. emitting charges to induce electrostatic fixation of ink particles 134 on print medium 90)

In one aspect, the above-mentioned closed loop validations of both the electrostatic discharging voltage and the electrostatic pinning voltage may be performed during normal, on-going operation of the image formation device 680.

In contrast, in the configuration of the scanning carriage 560 of FIG. 7A, the voltmeters 530A, 530B are arranged to enable performing closed loop validation of the discharge voltage during normal, on-going operation of the scanning carriage 560 of FIG. 7A. However, in some examples validation of the pinning voltage for scanning carriage 560 (FIG. 7A) comprises placing the image formation device in a non-printing mode (e.g. for calibration) and measuring voltages while making a pass without performing discharging with the applicable emitter (e.g. the emitter adjacent to the particular voltmeter). Moreover, in the configuration of the scanning carriage 460 of image formation device 400 of FIG. 6, the voltmeters 430A, 430B are arranged to enable performing closed loop validation of the pinning voltage during normal, on-going operation of the scanning carriage 460 of the image formation device 400 of FIG. 6. However, in some examples validation of the discharge voltage for scanning carriage 460 (FIG. 6) comprises placing the scanning carriage 460 in a non-printing mode (e.g. for calibration) and measuring voltages while making a pass without operating the fluid ejection device 80 and without operating the other respective emitter.

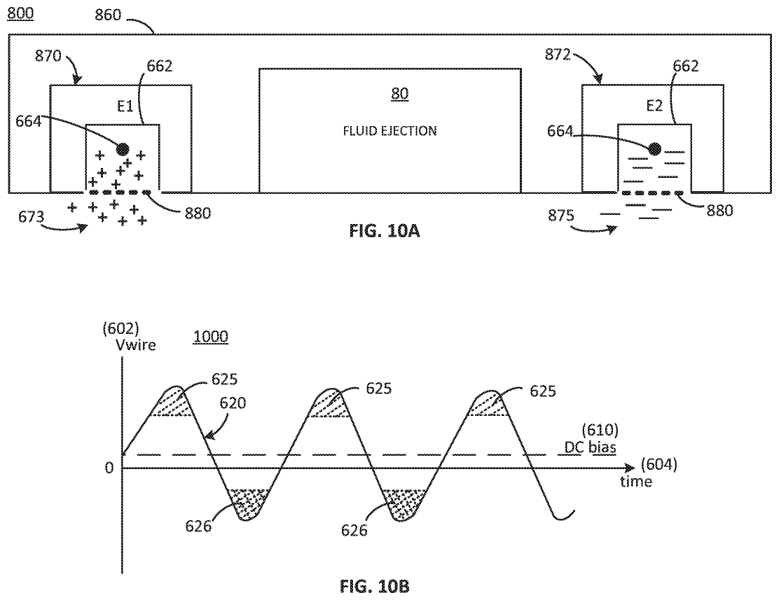

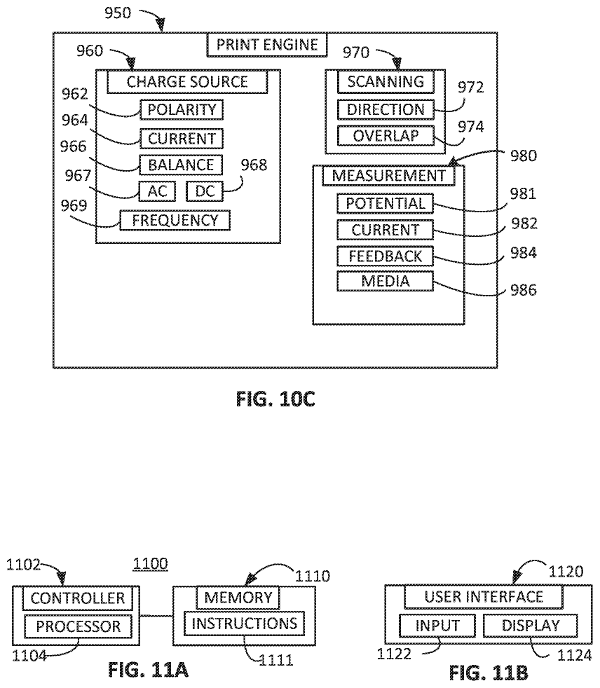

FIG. 10A is a diagram including a side view schematically representing an example image formation device 800 including scanning carriage 860. In some examples, the example image formation device 800 (including carriage 860) comprises at least some of substantially the same features and attributes as the image formation devices (and portions thereof) as previously described in association with FIGS. 1-5, along with each of the first emitter 870 (like emitter 70) and second emitter 872 (like emitter 72) comprising a scorotron 874. Each scorotron 874 comprises a corona wire 664 (as in FIG. 8) and in addition comprises a grid (or screen) 880 spaced apart from the corona wire 664. To operate a scorotron 874 as a charging emitter (e.g. emitter 70 in FIG. 10A) to emit positive charges for attachment to ink particles 134 (e.g. FIG. 2B-2C), the corona wire 664 of scorotron 874 may be operated with a DC bias, and the screen 880 may be operated with a DC bias at a potential desired to be reached at surface 93 of print medium 90. To operate a scorotron 874 as a discharging emitter (e.g. emitter 72 in FIG. 10A) to emit negative charges for neutralizing surface charges 74A at surface 93 of print medium 90, the corona wire 664 of scorotron 874 is operated with a AC bias and the screen 880 of emitter 72 is operated at 0 Volts (e.g. grounded), which corresponds to the target potential of the surface 93 of print medium 90 when emitter 72 is operated in a discharge mode. In some such examples, the AC bias for the corona wire may be operated at a target frequency such that, with knowledge of the travel speed of the carriage 860 across the print medium 90, enough AC cycles (e.g. 5-10 cycles) will occur over a given portion of the print medium to result in sufficient discharge at the surface 93 of the print medium 90.

Of course, as in previous examples, when a carriage is moving in an opposite direction, it will be understood that the roles of emitters 870, 872 may be reversed such that emitter 870 emits negative charges to act in a discharging mode and emitter 872 can emit positive charges to act in a charging mode, in a manner similar to that shown in FIGS. 1, 4A-4D, etc.

In some examples, the AC bias for the corona wire may be provided via sine wave excitation or any other periodic wave for the corona wire potential. In some such examples, such periodic excitation may also include a DC bias to compensate for any asymmetry between a threshold voltage of the negative corona and a threshold voltage of the positive corona, where the threshold voltage corresponds to a potential at which current emission from the corona starts. In some instances, this threshold voltage may be lower for a corona emitting negative charges.

In some examples, the graph 1000 in FIG. 10B may comprise substantially the same discharging behavior as shown in the graph 600 of FIG. 7B, except achieved via the use of scorotrons instead of separate non-contact electrostatic voltmeters (e.g. 430A, 430B in FIG. 6, 530A-530D in FIGS. 7A, 9).

With regard to the corona wires and scorotrons previously described throughout examples of the present disclosure, it will be understood that other plasma type devices may be employed to generate charges for discharging and/or discharging with such other plasma-type devices including but not limited to, pin-type corona discharge devices, dielectric barrier devices (DBD), and the like. In each of these instances, the plasma type device provides an ability to control a polarity (e.g. negative or positive) of the charges emitted by the plasma device and to selectively switch the polarity of the charge emitted, such as each time the scanning carriage reverses direction to make another pass across the width of the print medium 90.

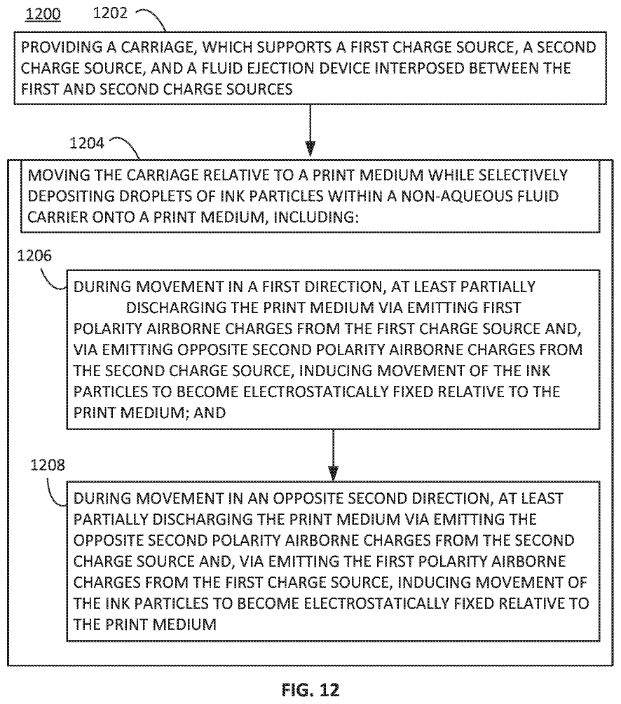

FIG. 10C is a block diagram schematically representing an example print engine 950. In some examples, the print engine 950 may form part of a control portion 1100, as later described in association with at least FIG. 11A, such as but not limited to comprising at least part of the instructions 1111 and/or information 1112. In some examples, the print engine 950 may be used to implement at least some of the various example devices and/or example methods of the present disclosure as previously described in association with FIGS. 1-10B and/or as later described in association with FIGS. 11A-12. In some examples, the print engine 950 (FIG. 10C) and/or control portion 1100 (FIG. 11A) may form part of, and/or be in communication with, an image formation device and/or scanning carriage of an image formation device.

In general terms, the print engine 950 is to control at least some aspects of operation of the image formation devices (including a carriage 60 and the elements supported thereon) as described in association with at least FIGS. 1-10B, and 11A-12. As shown in FIG. 10C, the print engine 950 may comprise a charge source engine 960, a scanning engine 970, and a measurement engine 1180. In general terms, the charge source engine 960 controls operation of each charge source (e.g. emitter 70, 72, etc.) supported by a carriage (e.g. 60, etc.). In some examples, the charge source engine 960 may comprise a polarity parameter 962, current parameter 964, balance parameter 966, AC parameter 967, DC parameter 968, and frequency parameter 969. In some examples, the polarity parameter 962 may control and/or track a polarity of each respective charge source (e.g. emitter 70, 72), while the current parameter 964 may control and/or track a current of each respective charge source (e.g. emitter 70, 72), such as the current at a corona wire. In some examples, the balance parameter 966 may control and/or track a relative balance of net charges deposited on the print medium by an emitter used for discharging with net charges deposited on the print medium by an emitter used for charging ink particles. In tracking such balances, some examples may comprise measuring the net current of each plasma device that reaches media, I_{M} as previously described in association with at least FIGS. 6-10B. In some such examples, the balance parameter 966 may control and/or track so that the deposited charges are balanced so that net current of an emitter in discharge mode is a negative value of the net current of an emitter in charging mode (e.g. used for electrostatic pinning).

In some examples, the balance parameter 966 may utilize the measured potential of print medium 90, as obtained via non-contact electrostatic voltmeters (e.g. 430A, 430B in FIG. 6, 530A, 530B in FIG. 7A, 530A-530D in FIG. 9), as feedback to compute the net current of the emitter in discharge mode based on the charges to be used to balance the previously deposited charges on the media.

In some examples, the balance parameter 966 may use the electrostatic voltmeters to calibrate the corona voltage (like wire DC voltage 610 or grid voltage 880) to achieve zero Volts in a close loop system. In some examples the electrostatic voltmeter may be used to calibrate the corona voltage (like wire 664 DC voltage) to get the desired pinning voltage, i.e. the voltage used to cause electrostatic fixation of ink particles 134 relative to print medium 90.

In some examples, the balance parameter 966 may cooperate with at least the polarity parameter 962 to operate emitters/charge sources with opposite sign potentials to balance (within some tolerance) the net charges deposited on the media to enable a print zone below both the fluid ejection device and emitter (in charge mode) to be neutral. In some such examples, the tolerance may comprise ±200V.

In some examples, the balance parameter 966 may cooperate with at least the polarity parameter 962, AC parameter 967, and/or DC parameter 968 to run coronas alternately with a DC bias or with an AC biased periodic waveform (with a DC bias potential) in order that the net charge deposited on the media by the DC corona is balanced (within some tolerance) by the net charge laid down by the AC corona to allow the print zone to be charge neutral, as previously described in association with at least FIGS. 7A, 9. In some such examples, the tolerance may comprise ±200V.

With further reference to FIG. 10A, in some examples, the balancing parameter 966 may cooperate with at least the polarity parameter 962, AC parameter 967, and/or DC parameter 968 to operate a scorotron (e.g. 870 when in a charging mode) with its corona wire in a DC-biased state and its grid/screen 880 at the target/pinning charging potential, while the other scorotron (e.g. 872 when in a discharge mode) is operated with an AC-biased corona wire and its grid/screen 880 at the target potential of the print medium 90 in the print zone, such as 0 Volts.

In some examples, the frequency parameter 969 may control and/or track a frequency of an AC bias of the charge source when deployed in an AC mode.

In general terms, the scanning engine 970 of print engine 950 controls operation of a carriage (e.g. 60, etc.) in its back-and-forth scanning movement relative to a print medium. In some examples, the scanning engine 970 may comprise a direction parameter 972 and an overlap parameter 974. The direction parameter 972 may control and/or track a direction of movement (e.g. 1^{st}, 2^{nd} in FIG. 1) of a scanning carriage relative to a print medium 90. In some such examples, based on the direction of movement per parameter 972, the print engine 950 may cause a change in polarity in the charge sources (e.g. emitter 70, 72) and/or cause an emission (or omission) of charges from at least one of the charge sources. In some examples, the overlap parameter 974 may control and/or track a degree of overlap of multiple back-and-forth passes by the scanning carriage in order to perform a complete image formation on a print medium 90. Such control of overlap may help manage spatial non-uniformities, such as via providing feedback to control emitters 70, 72 to strike an appropriate balance of net currents, as previously described above.

In general terms, the measurement engine 980 controls measurement of various parameters associated with operation of a scanning carriage. In some examples, such measurements may facilitate operation of the charge source engine 960, charge sources (e.g. emitters 70, 72), etc. In some examples, the measurement engine 980 may comprise a potential parameter 981, a current parameter 982, a feedback parameter 983, and a media parameter 984. The potential parameter 981 may track measurements of a potential of the print medium 90, scorotron grid 880, and/or other potentials of portions associated with the scanning carriage and/or other portions of the image formation device. The current parameter 982 may track measurements of a current of the emitters (e.g. corona wire, scorotron, etc.) and/or at other elements (e.g. print medium). The feedback parameter 983 may track measurements from one element (e.g. non-contact electrostatic voltmeter 430A in FIG. 6) in order to determine an output of another element (e.g. a charge source such as emitter 70, 72). The media parameter 984 may track various physical or electrical parameters of a print medium, such as but not limited to, its dielectric thickness, media thickness, permittivity, etc., with values of such parameters being measured or otherwise previously stored in memory for use in operating a scanning carriage as part of an image formation device.

It will be understood that, in at least some examples, the print engine 950 is not strictly limited to the particular grouping of parameters, engines, functions, etc. as represented in FIG. 10C, such that the various parameters, engines, functions, etc. may operate according to different groupings than shown in FIG. 10C.

FIG. 11A is a block diagram schematically representing an example control portion 1100. In some examples, control portion 1100 provides one example implementation of a control portion forming a part of, implementing, and/or generally managing the example image formation devices, as well as the particular portions, carriages, fluid ejection devices, emitters, liquid removal devices, voltmeters, elements, devices, user interface, instructions, engines, parameters, functions, and/or methods, as described throughout examples of the present disclosure in association with FIGS. 1-10B and 12.

In some examples, control portion 1100 includes a controller 1102 and a memory 1110. In general terms, controller 1102 of control portion 1100 comprises at least one processor 1104 and associated memories. The controller 1102 is electrically couplable to, and in communication with, memory 1110 to generate control signals to direct operation of at least some the image formation devices, various portions and elements of the image formation devices, such as carriages, fluid ejection devices, emitters, liquid removal devices, voltmeters, user interfaces, instructions, engines, functions, and/or methods, as described throughout examples of the present disclosure. In some examples, these generated control signals include, but are not limited to, employing instructions 1111 stored in memory 1110 to at least direct and manage depositing droplets of ink particles and carrier fluid to form an image on a media, moving a carriage, jetting droplets, directing charges onto ink particles, removing liquids, discharging a print medium, measuring potentials and/or currents, etc. as described throughout the examples of the present disclosure in association with FIGS. 1A-10B and 12. In some instances, the controller 1102 or control portion 1100 may sometimes be referred to as being programmed to perform the above-identified actions, functions, etc. In some examples, at least some of the stored instructions 1111 are implemented as a, or may be referred to as, a print engine, an image formation engine, and the like, such as but not limited to the print engine 950 in FIG. 10C.

In response to or based upon commands received via a user interface (e.g. user interface 1120 in FIG. 11B) and/or via machine readable instructions, controller 1102 generates control signals as described above in accordance with at least some of the examples of the present disclosure. In some examples, controller 1102 is embodied in a general purpose computing device while in some examples, controller 1102 is incorporated into or associated with at least some of the image formation devices, portions or elements along the travel path, fluid ejection devices, charge emitters, liquid removal devices, voltmeters, user interfaces, instructions, engines, functions, and/or methods, etc. as described throughout examples of the present disclosure.

For purposes of this application, in reference to the controller 1102, the term “processor” shall mean a presently developed or future developed processor (or processing resources) that executes machine readable instructions contained in a memory or that includes circuitry to perform computations. In some examples, execution of the machine readable instructions, such as those provided via memory 1110 of control portion 1100 cause the processor to perform the above-identified actions, such as operating controller 1102 to implement the formation of an image as generally described in (or consistent with) at least some examples of the present disclosure. The machine readable instructions may be loaded in a random access memory (RAM) for execution by the processor from their stored location in a read only memory (ROM), a mass storage device, or some other persistent storage (e.g., non-transitory tangible medium or non-volatile tangible medium), as represented by memory 1110. The machine readable instructions may include a sequence of instructions, a processor-executable machine learning model, or the like. In some examples, memory 1110 comprises a computer readable tangible medium providing non-volatile storage of the machine readable instructions executable by a process of controller 1102. In some examples, the computer readable tangible medium may sometimes be referred to as, and/or comprise at least a portion of, a computer program product. In other examples, hard wired circuitry may be used in place of or in combination with machine readable instructions to implement the functions described. For example, controller 1102 may be embodied as part of at least one application-specific integrated circuit (ASIC), at least one field-programmable gate array (FPGA), and/or the like. In at least some examples, the controller 1102 is not limited to any specific combination of hardware circuitry and machine readable instructions, nor limited to any particular source for the machine readable instructions executed by the controller 1102.

In some examples, control portion 1100 may be entirely implemented within or by a stand-alone device.

In some examples, the control portion 1100 may be partially implemented in one of the image formation devices and partially implemented in a computing resource separate from, and independent of, the image formation devices but in communication with the image formation devices. For instance, in some examples control portion 1100 may be implemented via a server accessible via the cloud and/or other network pathways. In some examples, the control portion 1100 may be distributed or apportioned among multiple devices or resources such as among a server, an image formation device, and/or a user interface.

In some examples, control portion 1100 includes, and/or is in communication with, a user interface 1120 as shown in FIG. 11B. In some examples, user interface 1120 comprises a user interface or other display that provides for the simultaneous display, activation, and/or operation of at least some of the image formation devices, portions thereof, elements, user interfaces, instructions, engines, functions, and/or methods, etc. as described in association with FIGS. 1-11A and 12. In some examples, at least some portions or aspects of the user interface 1120 are provided via a graphical user interface (GUI), and may comprise a display 1124 and input 1122.

FIG. 12 is a flow diagram schematically representing an example method. In some examples, method 1200 may be performed via at least some of the same or substantially the same image formation devices, portions, carriages, fluid ejection devices, charge emitters, liquid removal devices, elements, control portion, user interface, etc. as previously described in association with FIGS. 1A-11B. In some examples, method 1200 may be performed via at least some image formation devices, portions, carriages, fluid ejection devices, charge emitters, liquid removal devices, elements, control portion, user interface, etc. other than those previously described in association with FIGS. 1A-11B.

In some examples, as shown at 1202 in FIG. 12, method 1200 comprises providing a carriage supporting a first charge source, a second charge source, and a fluid ejection device interposed between the first and second charge sources.

As further shown in FIG. 12 at 1204, in some examples method 1200 comprises moving the carriage relative to a print medium while selectively depositing droplets of ink particles within a non-aqueous fluid carrier onto a print medium to form an image on the print medium. In some examples, this arrangement (at 1204) may include, as shown at 1206, during movement in a first direction, at least partially discharging the print medium via emitting first polarity airborne charges from the first charge source and, via emitting opposite second polarity airborne charges from the second charge source, inducing movement of the ink particles to become electrostatically fixed relative to the print medium. In some examples, this arrangement (at 1204) may include, as shown at 1208, during movement in an opposite second direction, at least partially discharging the print medium via emitting the opposite second polarity airborne charges from the second charge source and, via emitting the first polarity airborne charges from the first charge source, inducing movement of the ink particles to become electrostatically fixed relative to the print medium.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. A scanning printer comprising:
a carriage supporting:
a first emitter to emit first airborne charges;
a second emitter to emit second airborne charges;
a fluid ejection device interposed between the first and second emitters to deposit droplets of ink particles within a non-aqueous fluid carrier onto a print medium,
wherein the carriage is movable relative to the print medium:
in a first direction in which the first emitter is to electrostatically discharge the medium and the second emitter is to induce electrostatic fixation of the ink particles relative to the medium; and
in an opposite second direction in which the second emitter is to electrostatically discharge the medium and the first emitter is to induce electrostatic fixation of the ink particles relative to the medium.

2. The printer of claim 1, wherein in a first pass of the carriage over a previously-unprinted-portion of the print medium, a portion of the first emitter does not emit airborne charges to discharge the previously-unprinted-portion of the print medium.

3. The printer of claim 1, wherein the carriage comprises:
a first liquid removal portion to remove at least a portion of the liquid carrier from the print medium, wherein the first emitter is interposed between the first liquid removal portion and the fluid ejection device; and
a second liquid removal portion to remove at least a portion of the liquid carrier from the print medium, wherein the second emitter is interposed between the second liquid removal portion and the fluid ejection device.

4. The printer of claim 3, wherein each respective first and second liquid removal portion comprises at least one of:
a heated air element to direct heated air onto at least one of the carrier fluid and the non-transfer medium; or
a radiation device to direct at least one of IR radiation and UV radiation onto the carrier fluid and the non-transfer medium.

5. The printer of claim 1, comprising:
a grounded support to support the print medium at least during electrostatic pinning.

6. The printer of claim 1, wherein in the first direction of movement of the carriage unit, the first emitter is in a leading position relative to the fluid ejection device and the second emitter is in a trailing position relative to the fluid ejection device, and in the second direction of movement of the carriage, the second emitter is in the leading position and the first emitter is in the trailing position.

7. The printer of claim 6, comprising:
a first non-contact electrical potential sensing device positioned between the first emitter and a first end of the carriage;
a second non-contact electrical potential sensing device positioned between the second emitter and a second end of the carriage; and
at least one of:
wherein upon being in the leading position, a respective one of the first and second electrical potential sensing devices is to measure a potential of the print medium prior to discharge to enable determination of a current to be applied via a respective one of the first and second emitters to discharge the print medium; and
wherein upon being in the trailing position, a respective one of the first and second electrical potential sensing devices is to measure a potential of the print medium after charging the ink particles to enable determination of a current to be applied via a respective one of the first and second emitters to cause electrostatic fixation of the ink particles relative to the print medium.

8. The printer of claim 1,
a first non-contact electrostatic voltmeter interposed between the fluid ejection device and the first emitter; and
a second non-contact electrostatic voltmeter interposed between fluid ejection device and the second emitter,
wherein upon being in the leading position, a respective one of the first and second voltmeters is to measure a potential of the print medium after the discharge to enable control of a DC bias level of an AC discharge current of the respective first and second emitters in order to discharge the print medium.

9. The printer of claim 1,
wherein a respective one of the first and second emitters comprises a first scorotron to at least partially control a potential of the print medium at least during discharge of the print medium, and
wherein a respective one of the first and second emitters comprises a second scorotron to at least partially control a potential of the print medium at least during charging of the ink particles.

10. The printer of claim 9, wherein the first scorotron includes a first corona to be operated in a DC bias mode and a first grid to be at a target potential for electrostatic fixation, and wherein the second scorotron includes a second corona to be operated in an AC bias mode and a second grid to be at a target potential for discharging the print medium.

11. A scanning printer comprising:
a carriage supporting:
a first charge source to emit first airborne charges;
a second charge source to emit second airborne charges;
a fluid ejection device interposed between the first and second charge sources to deposit droplets of ink particles within a non-aqueous fluid carrier onto a print medium,
wherein the carriage is movable relative to the print medium during which a respective one of the first and second charge sources is operated in discharge mode to neutralize charges on the print medium and the other respective one of the first and second charge sources is operated in a charge mode to charge the deposited ink particles to induce electrostatic fixation of the ink particles relative to the print medium;
at least one measurement element to measure a first net current and a second net current directed toward the print medium, respectively, by each of the respective first and second charge sources; and
a control portion to control, based on the measured first and second net currents, the first net current of a respective one of the first and second charge sources when operated in the discharge mode to be an opposite value of the second net current of a respective one of the first and second charge sources when operated in the charge mode.

12. The scanning printer of claim 10, wherein the at least one measurement element comprises:
a first non-contact voltmeter positioned adjacent the first charge source; and
a second non-contact voltmeter positioned adjacent second charge source,
wherein upon being in a leading position during movement of the carriage, a respective one of the first and second voltmeters is to measure a potential of the print medium prior to discharge to enable determination of a current to be applied via a respective one of the first and second charge sources to discharge the print medium.

13. A method comprising:
providing a carriage, which supports a first charge source, a second charge source, and a fluid ejection device interposed between the first and second charge sources;
moving the carriage relative to a print medium while selectively depositing droplets of ink particles within a non-aqueous fluid carrier onto a print medium, including:
during movement in a first direction, at least partially discharging the print medium via emitting first polarity airborne charges from the first charge source and, via emitting opposite second polarity airborne charges from the second charge source, inducing movement of the ink particles to become electrostatically fixed relative to the print medium; and
during movement in an opposite second direction, at least partially discharging the print medium via emitting the opposite second polarity airborne charges from the second charge source and, via emitting the first polarity airborne charges from the first charge source, inducing movement of the ink particles to become electrostatically fixed relative to the print medium.

14. The method of claim 13, comprising:
during each initial pass of a portion of the carriage unit over a previously-unprinted portion of a print medium, omitting emission of respective first airborne charges or opposite second airborne charges to discharge the print medium.

15. The method of claim 13, comprising:
arranging the first charge source to be in a leading position relative to the fluid ejection device and the second charge source to be in a trailing position relative to the fluid ejection device during movement of the carriage in the first direction; and
arranging the second charge source to be in the leading position relative to the fluid ejection device and the first charge source to be in the trailing position relative to the fluid ejection device during movement of the carriage in the opposite second direction.
